(19) United States
(12) Patent Application Publication
(10) Pub. No.: US 2020/0327612 A1
(43) Pub. Date: Oct. 15, 2020

(54) CURRENCY EXCHANGE SYSTEM AND REMITTANCE SYSTEM

(71) Applicant: Atom Solutions Co., Ltd., Tokyo (JP)

(72) Inventor: Hirokazu HAYASHI, Tokyo (JP)

(21) Appl. No.: 16/755,104

(22) PCT Filed: Oct. 1, 2018
(86) PCT No.: PCT/JP2018/036710

§ 371 Date: Apr. 9, 2020

(30) Foreign Application Priority Data
Oct. 13, 2017 (JP) 2017198996

(51) Int. Cl. G06Q 40/04; G06Q 20/06; G06Q 40/02; G06Q 20/38; G06Q 20/08; G06F 16/23

(52) U.S. Cl. CPC G06Q 40/04; G06Q 20/0655; G06F 16/2379; G06Q 20/381; G06Q 20/085; G06Q 40/025

(57) ABSTRACT

[Problem] To provide a currency exchange system and a remittance system which prevent the amount of money received from being less than expected as a result of the remittance of virtual currency. [Solution] A remittance system 1 is provided with a plurality of user terminals 2, a marketplace server 3, and a management server 4. The marketplace server 3 is provided with: a user information database 32a which stores balance information of a virtual currency and a flat currency for each user, a pool information database 32b which stores balance information of a third party lending virtual currency, which is a virtual currency loaned from a third party user, and an automated trading means 31a which upon receipt of a currency exchange instruction, uses any of first and second fiat currencies to buy the third party lending virtual currency corresponding to a currency exchange amount included in the currency exchange instruction, and sells the third party lending virtual currency and buys the other of the first and second fiat currencies, thereby exchanging the first and second fiat currencies.

### TECHNICAL FIELD

The present invention relates to a currency exchange system and a remittance system using virtual currency.

### BACKGROUND ART

A remittance system using a virtual currency has been conventionally known. In the disclosure of Patent Literature 1, after a virtual currency is market-bought by a first fiat currency, a second fiat currency is market-sold by a second fiat currency to easily make a remittance on the basis of the fiat currencies.

### CONVENTIONAL ART LITERATURE

### Patent Literature

Patent Literature 1: Japanese Published Unexamined Application No. 2017-54338

### SUMMARY OF THE INVENTION

### Problem to be Solved by the Invention

However, in the remittance system described in Patent Literature 1, when a virtual currency is market-bought by a first fiat currency or when the virtual currency is market-sold by a second fiat currency, if board information does not include a sufficient number of buying orders or sell orders, the virtual currency is bought at a higher price than expected or the virtual currency is sold at a lower price than expected. For this reason, an amount of money received may be small especially when a large amount of money is remitted.

Thus, a technical problem to be solved to prevent an amount of money received from being less than expected as a result of the remittance of virtual currency, and the present invention has as its object to solve the problem.

### Means for Solving the Problem

In order to achieve the problem, an exchange system according to the present invention is an exchange system which relatively exchanges first and second fiat currencies between users through a virtual currency, including a user information DB which stores balance information of the virtual currency and the fiat currency for each user; a pool information DB which stores balance information of a third party lending virtual currency, which is a virtual currency loaned from a third party user; and an automated trading means which upon receipt of a currency exchange instruction, uses any of first and second fiat currencies to buy the third party lending virtual currency corresponding to a currency exchange amount included in the currency exchange instruction, and sells the third party lending virtual currency and buys the other of the first and second fiat currencies so as to exchange the first and second fiat currencies.

According the configuration, the automated trading means relatively exchanges the first and second fiat currencies through the third party lending virtual currency stored in the pool information DB to make it possible to exchange the first and second fiat currencies at a currency exchange ratio and quantities on which the users agree. For this reason, in comparison with an exchange through a marketplace, an amount of money received can be prevented from being small.

The exchange system according to the present invention, the pool information DB stores a lending date of the third party lending virtual currency, and the automated trading means preferably uses the third party lending virtual currency in order of oldest of the lending date in the exchange of the first and second fiat currencies.

According to the configuration, the automated trading means can use the third party lending virtual currency in order of oldest of the lending date in the exchange of the first and second fiat currencies.

The exchange system according to the present invention, the pool information DB stores a loan interest of the third party lending virtual currency, further including an interest collecting means which, when the first and second fiat currencies are exchanged through the third party lending virtual currency, collects the loan interest from the balance information of the virtual currency of a user who makes the exchange and distributes the loan interest to a third party user which lends out the third party lending virtual currency.

According to the configuration, the interest collecting means can distribute a loan interest collected from a user who makes an exchange to a third party user to which a virtual currency lends the third party lending virtual currency.

In addition, in the exchange system, the loan interest is preferably set to different values in units of fiat currencies corresponding to the third party lending virtual currency.

According to the configuration, different loan rates in units of fiat currencies are set to a virtual currency exchanged from various fiat currencies so as to make it possible to urge a user to purchase a fiat currency corresponding to a high-interest virtual currency.

In order to solve the problem, a remittance system according to the present invention includes the following remittance system.

According to the configuration, the automated trading means relatively exchanges the first and second fiat currencies through the third party lending virtual currency stored in the pool information DB to make it possible to exchange the first and second fiat currencies at a currency exchange ratio and quantities on which the users agree. For this reason, in comparison with an exchange through a marketplace, an amount of money received can be prevented from being small.

### Advantages

According to the present invention, the automated trading means relatively exchanges the first and second fiat currencies through the third party lending virtual currency stored in the pool information DB to make it possible to exchange the first and second fiat currencies at a currency exchange ratio and quantities on which the users agree. For this reason, in comparison with an exchange through a marketplace, an amount of money received can be prevented from being small.

### BRIEF DESCRIPTION OF THE DRAWINGS

FIG. 1 is a block diagram showing a remittance system using a virtual currency according to an embodiment of the present invention.

FIG. 2 is a flow chart showing a procedure exchanging cash for a fiat currency.

FIG. 3 is a flow chart showing a procedure buying a fiat currency.

FIG. 4 is a flow chart showing a procedure of international remittance in which a buying order of a virtual currency by a remittance source user and a selling order of the virtual currency by a remittance destination user.

FIG. 5 is a diagram showing an image of an exchange of first and second fiat currencies through a third party lending virtual currency.

FIG. 6 is a flow chart showing a procedure of exchanging the fiat currency between users through the virtual currency.

FIG. 7 is a table showing an amount of virtual currency lent from a third party before an exchange is made and a rank order of the virtual currency.

FIG. 8 is a table showing an amount of virtual currency lent from a third party after an exchange is made and a rank order of the virtual currency.

### MODES FOR CARRYING OUT THE INVENTION

An embodiment of the present invention will be described below with reference to the accompanying drawings. In the following description, when the numbers, numerical values, quantities, ranges, and the like of constituent elements are mentioned, unless otherwise specified or except that the numbers are limited to theoretically clear numbers, the numbers are not specific numbers and may be larger or less than the specific numbers.

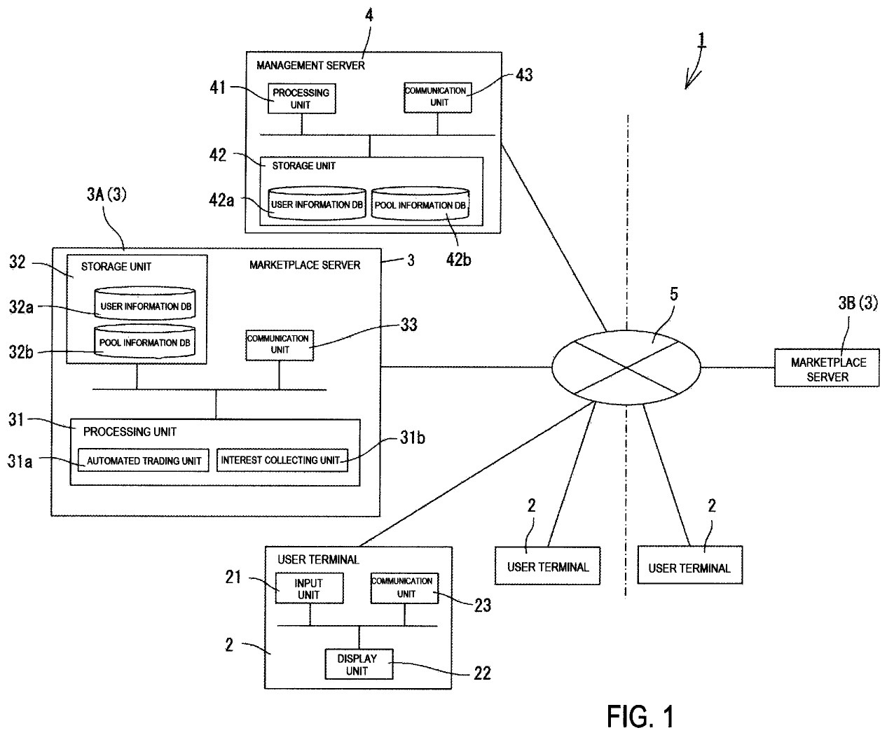

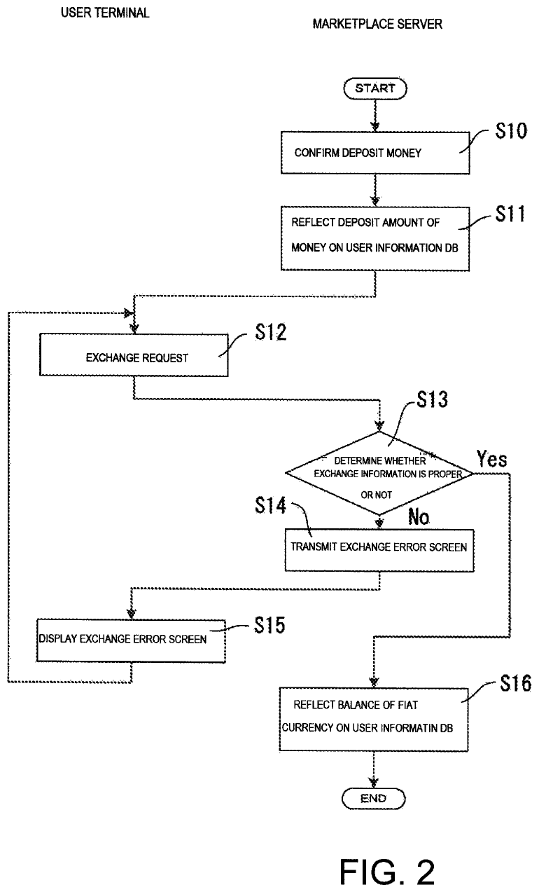

FIG. 1 is a block diagram showing the configuration of a remittance system.

The remittance system 1 can trade a virtual currency (hub currency) by a fiat currency corresponding to cash to make it possible to remit the virtual currency between users. More specifically, although cashes and fiat currencies are different from each other in different countries, respectively, a virtual currency traded by the fiat currencies are common in all countries, and each of the users can casually remit the virtual currency 24 hours anytime. The remittance system 1 includes a user terminal 2, a marketplace server 3, and a management server 4. The remittance system 1 can also relatively exchange different fiat currencies as described later, and functions as an exchange system performing such an exchanging function.

The user terminal 2 includes an input unit 21, a display unit 22, and a communication unit 23. The user terminal 2 is a computer, a cellular phone, a PDA, or the like. The input unit 21 is, for example, a keyboard, a mouse, a touch panel, or the like. The display unit 22 is, for example, a display.

One marketplace server 3 is installed in each country. The marketplace server 3 issues a fiat currency corresponding to the cash in the country in which the server is installed. The marketplace server 3 includes a processing unit 31, a storage unit 32, and a communication unit 33. In the following explanation, when marketplace servers installed in different countries are generically called, reference numeral 3 is given to the marketplace servers, and, when the marketplace servers are discriminated from each other, A and B are added to the ends of reference numerals, respectively, to discriminate the marketplace servers from each other.

The processing unit 31 has, for example, a CPU, a memory, and the like. The processing unit 31 includes an automated trading unit 31a, and an interest collecting unit 31b.

The storage unit 32 is, for example, a nonvolatile storage device such as a hard disk drive or a flash memory. The storage unit 32 includes a user information DB 32a and a pool information DB 32b (will be described later).

The communication unit 33 is communicably connected to the communication unit 23 through a network 5.

The management server 4 includes a processing unit 41, a storage unit 42, and a communication unit 43. The processing unit 41 has, for example, a CPU, a memory, and the like. The storage unit 42 is, for example, a nonvolatile storage device such as a hard disk drive or a flash memory. The storage unit 42 includes a user information DB 42a and a pool information DB 42b (will be described later). The communication unit 43 is communicably connected to the communication unit 33 through the network 5.

The user information DB 32a of the marketplace server 3 stores user information related to a user in a country in which the marketplace server 3 is installed. As the user information, for example, user specifying information such as a user name, a corporate name, an address, a mail address, a telephone number, and a facsimile number, account information related to a banking facility, balance information of cash, a virtual currency, and a fiat currency, and the like.

The user information DB 42a of the management server 4 is synchronized with the user information DB 32a of the marketplace server 3 and stores user information of all users.

The pool information DB 32b of the marketplace server 3 stores a lender, a lending amount, a lending date, and a loan interest of a virtual currency (to be referred to as a “third party lending virtual currency hereinafter) lent from a user in a country in which the marketplace server 3 is installed.

The pool information DB 42b of the management server 4 is synchronized with the pool information DBs 32b of all the marketplace servers 3 and stores a lender, a lending amount, a lending date, and a loan interest of all the third party lending virtual currencies.

An operation of the remittance system 1 will be explained below with reference to the drawings.

When the marketplace server 3 confirms a deposit of money (S10), the marketplace server 3 reflects a deposit amount of money on balance information of cash of the user information DB 32a (S11).

In response to an input operation through the input unit 21 of a user, the user terminal 2 transmit a currency exchange instruction which exchanges cash for a fiat currency to the marketplace server 3 (S12). The currency exchange instruction includes an amount of fiat currency to be exchanged or the like. In general, an exchange ratio of the fiat currency to the cash is 1:1.

The marketplace server 3 determines whether the currency exchange instruction is proper or not (S13). More specifically, the marketplace server 3 determines whether a balance of the cash of the user stored in the user information DB 32a is equal to or larger than an amount of cash included in the currency exchange instruction.

When the balance of cash stored in the user information DB 32a is insufficient (No in S13), the marketplace server 3 transmits an exchange error screen (S14), and the exchange error screen is displayed on the display unit 22 (S15).

When the balance of cash is sufficient (Yes in S13), the marketplace server 3 exchanges the cash for the fiat currency to update the amounts of exchanged cash and fiat currency in the user information DB 32a (S16).

Although the exchange request described above has been explained with respect to the case in which the cash is exchanged for the fiat currency, the exchange request is made by the same manner as described above when the fiat currency is exchanged for cash.

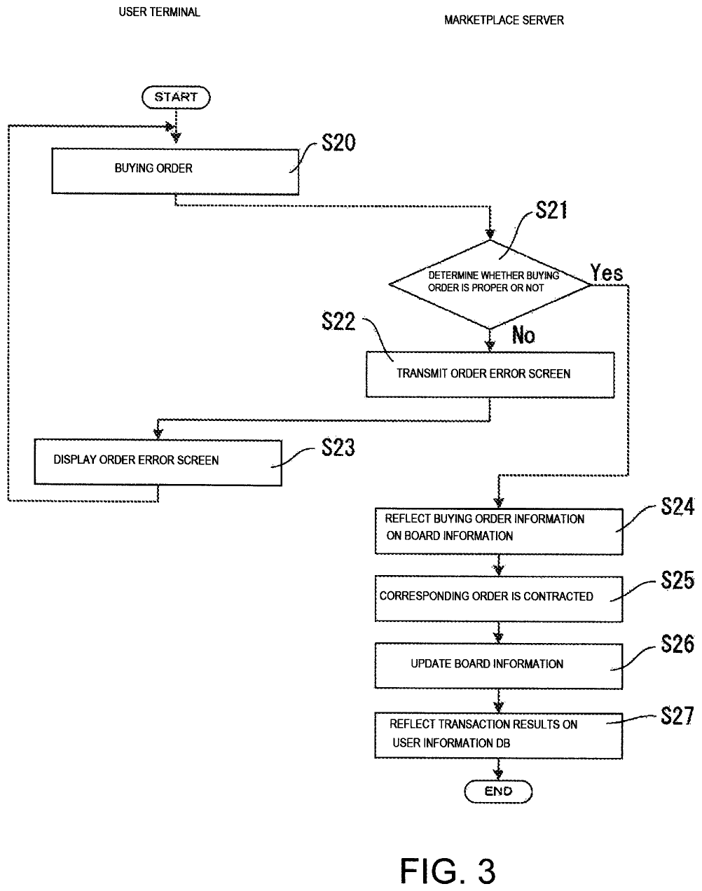

FIG. 3 is a flow chart showing a procedure of purchasing a virtual currency by a fiat currency through a marketplace.

The user terminal 2 receives an input operation through the input unit 21 of a user, and requests a buying instruction of the virtual currency from the marketplace server 3 (S20). The buying instruction includes a buying amount of virtual currency, the value of virtual currency, and the like.

The marketplace server 3 determines whether a buying instruction of a virtual currency is proper or not (S21). More specifically, the marketplace server 3 determines whether the amount of fiat currency stored in the user information DB 32a is sufficient for an amount of fiat currency required to buy the virtual currency. The amount of fiat currency required to buy the virtual currency is a product of the buying amount and the value of virtual currency included in the buying instruction.

When the amount of fiat currency stored in the user information DB 32a is smaller than the amount of fiat currency required to buy the virtual currency (No in S21), the marketplace server 3 transmits an order error screen (S22), and the order error screen is displayed on the display unit 22 (S23).

When the amount of fiat currency stored in the user information DB 32a is equal to or larger than the amount of fiat currency required to buy the virtual currency (Yes in S21), the marketplace server 3 reflects the buying amount and the value of virtual currency included in the buying instruction (S24).

When a selling order corresponding to a buying order is reflected on board information, the buying order is contracted (S25), and the buying order is erased from the board information (S26), a buying amount and a value of virtual currency are reflected on the user information DB 32a, and the amount of fiat currency is subtracted (S27).

Although the buying order described above has been explained as a limit order, the buying order is made by the same manner as described above as a market order. In addition, in the embodiment described above, although a buying order of the virtual currency has been explained, a selling order of the virtual currency is processed by the same procedure as described above.

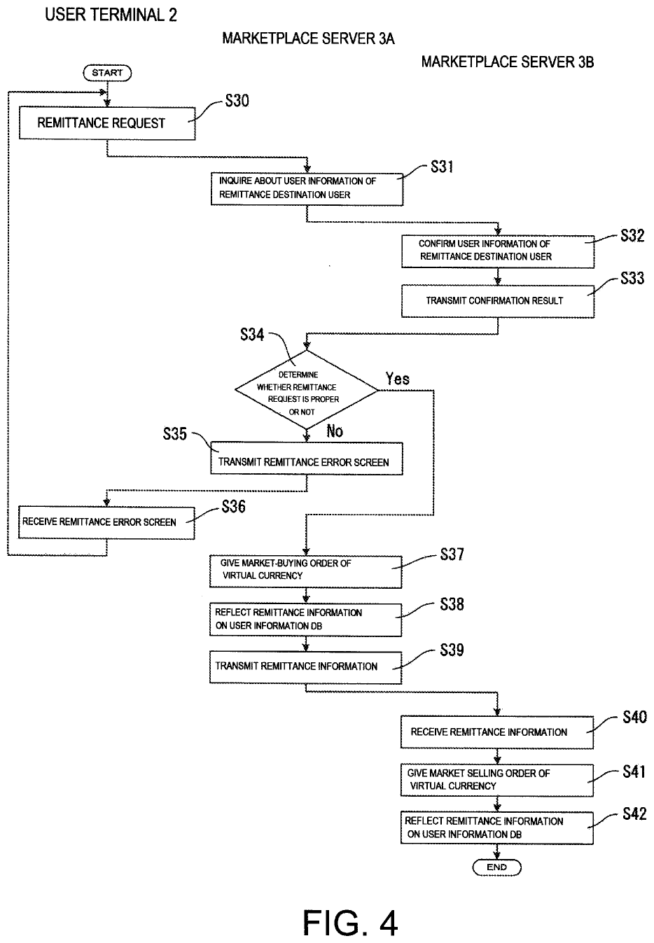

FIG. 4 is a flow chart showing a procedure of international remittance. In the following description, a country in which a marketplace server storing user information of a remittance source user is installed and a country in which a marketplace server storing user information of a remittance destination user is installed are assumed as Japan and Republic of the Philippines, respectively. In addition, a fiat currency circulated in Japan and a fiat currency circulated in Republic of the Philippines are assumed as a first fiat currency JPY and a second fiat currency PHP, respectively.

The user terminal 2, in response to an input operation through the input unit 21 of the user, requests a remittance instruction of a virtual currency XEC from a marketplace server 3A installed in Japan (S30). The remittance instruction includes the country (Republic of the Philippines) of the marketplace server 3B storing user information of a remittance destination user, an account number of the remittance destination user, an account holder's name, an amount of virtual currency XEC to be remitted, and the like.

The marketplace server 3A installed in Japan inquires a marketplace server 3B installed in Republic of the Philippines about the account number of the remittance destination user and the account holder's name (S31).

The marketplace server 3B confirms whether the account number of the remittance destination user and the account holder's name are proper or not (S32), and sends back the result to the marketplace server 3A (S33).

The marketplace server 3A, in response to the replay from the marketplace server 3B, determines whether a remittance request is proper or not (S34). More specifically, the marketplace server 3A determines the amount of first fiat currency JPY of the remittance source user stored in the user information DB 32a is equal to or larger than the amount required for market-buying an amount of virtual currency XEC included in the remittance request.

When the result in step S33 or the amount of first fiat currency JPY is insufficient (No in S34), the marketplace server 3A transmits a remittance error screen (S35), and the remittance error screen is displayed on the display unit 22 (S36).

When the result in step S33 is proper, and when the amount of first fiat currency JPY is sufficient (Yes in S34), the processing unit 31 reflects a market-buying order of the amount of virtual currency XEC included in the remittance instruction on board information (S37).

The processing unit 31 decides the amount of fiat currency JPY required to purchase the virtual currency XEC, and decreases the amount of first fiat currency JPY of the remittance source user stored in the user information DB 32a (S38). In addition, the marketplace server 3A transmits the remittance instruction to the marketplace server 3B (S39).

When the marketplace server 3B receives the remittance instruction (S40), the processing unit 31 reflects a market-selling order of the amount of virtual currency XEC included in the remittance instruction on the board information (S41). The processing unit 31 decides an amount of second fiat currency PHP obtained by selling the virtual currency XEC, and increases the amount of second fiat currency PHP of the remittance destination user stored in the user information DB 32a (S42).

However, when international remittance is made by the procedure described above, the thickness (volumes of buying order and selling order) of the board information is not sufficient, a contract may be made at a price different from a supposed price, and an amount of money received in remittance may decrease. Thus, in the remittance system according to the present invention, an amount of money received in remittance is prevented from being small by an over-the-counter transaction (matching transaction) between users.

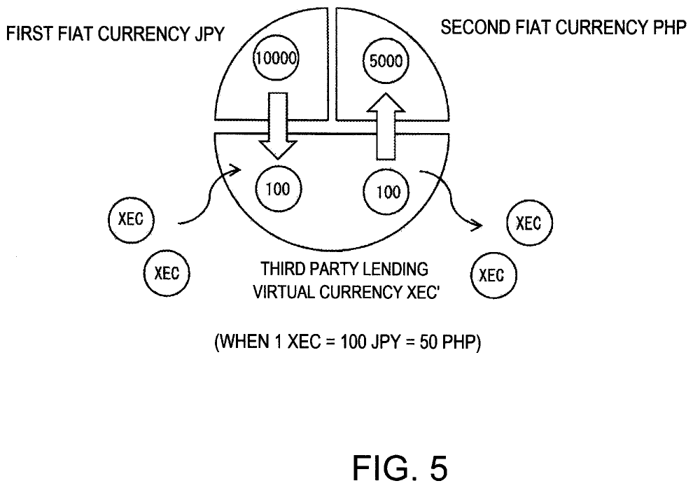

An outline of a procedure of exchanging the first fiat currency JPY and the second fiat currency PHP through the virtual currency XEC lent by a third party user (to be referred to as a “lending user” hereinafter) will be briefly explained on the basis of FIG. 5.

FIG. 5 is a diagram showing an image of an exchange of the first fiat currency JPY and the second fiat currency PHP, second fiat through the virtual currency XEC lent by a lending user. In the following description, it is assumed that an exchange ratio of the first fiat currency JPY, the second fiat currency PHP, and the virtual currency XEC is set to be the virtual currency XEC: the first fiat currency JPY: the second fiat currency PHP=1:100:50. A case in which the first fiat currency JPY the amount of which is 10000 is exchanged for the second fiat currency PHP the amount of which is 5000 will be exemplified.

The virtual currency XEC lent by the lending user is pooled in advance (up arrow in FIG. 5). The pooled virtual currency XEC is called a third party lending virtual currency XEC′. An amount of virtual currency XEC lent by each user and the like are stored in the pool information DBs 32b and 42b. The virtual currency XEC is lent by sending a lending instruction to the marketplace server 3 through the user terminal 2 by a user. The lending instruction includes a lending amount of virtual currency XEC or the like.

After the third party lending virtual currency XEC′ the amount of which is 100 is purchased by the first fiat currency JPY the amount of which is 10000 (down arrow in FIG. 5), the second fiat currency PHP the amount of which is 5000 is acquired by the third party lending virtual currency XEC′ the amount of which is 100 (up arrow in FIG. 5).

The third party lending virtual currency XEC′ interposed in the exchange is returned to the user lending the virtual currency XEC after the exchange is completed (right down arrow in FIG. 5).

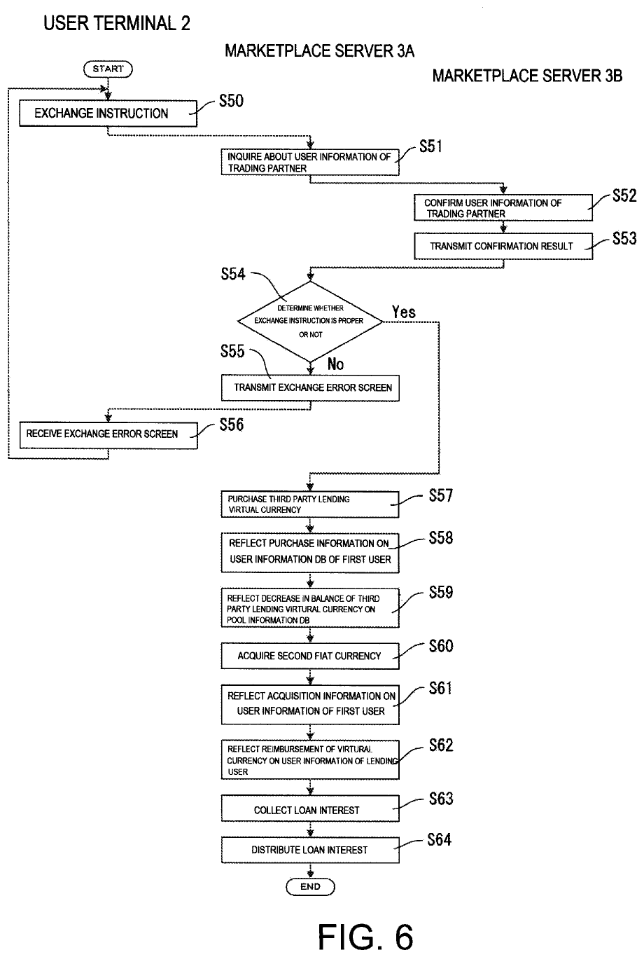

A procedure of exchanging the first and second fiat currencies through the virtual currency lent by the lending user will be explained in detail. FIG. 6 is a flow chart showing a procedure of over-the-counter-exchanging the fiat currencies through the virtual currency between users.

The user terminal 2, in response to an input operation through the input unit 21 of a first user, requests an exchange request including an exchange ratio and amounts of the first fiat currency JPY, the second fiat currency PHP, and the virtual currency XEC which the first and second users agree from the marketplace server 3A installed in Japan (S50).

The marketplace server 3A installed in Japan inquires the marketplace server 3B installed in Republic of the Philippines about the account number and the account holder's name of the second user who is a trading partner (S51).

The marketplace server 3B confirms whether the account number and the account holder's name of the second user are proper or not (S52), and the result is returned to the marketplace server 3A (S53).

The marketplace server 3A, in response to the replay from the marketplace server 3B, determines whether the currency exchange instruction is proper or not (S54). More specifically, the marketplace server 3A determines whether the amount of first fiat currency JPY of the first user stored in the user information DB 32a is equal to or larger than the amount (10000) of first fiat currency JPY included in the currency exchange instruction and whether the balance of the virtual currency XEC is equal to or larger than a loan interest (will be described later).

When the result in step S53 is not proper or when the amounts of first fiat currency JPY and virtual currency XEC are insufficient (No in S54), the marketplace server 3A transmits an exchange error screen (S55), and the exchange error screen is displayed on the display unit 22 (S56).

When the result in step S53 is proper and the amount of first fiat currency JPY is sufficient (Yes in S54), the automated trading unit 31a purchases the third party lending virtual currency XEC′ the amount of which is 100 by the first fiat currency JPY the amount of which is 10000 at an exchange ratio included in the currency exchange instruction (S57).

The automated trading unit 31a updates the user information DB 32a to subtract 10000 first fiat currencies JPY required to purchase the third party lending virtual currency XEC′ from the balance of the first fiat currency JPY (S58).

The automated trading unit 31a updates the pool information DB 32b to decrease the balance of the third party lending virtual currency XEC′ by the amount of third party lending virtual currency XEC′ purchased by the first fiat currency JPY (S59).

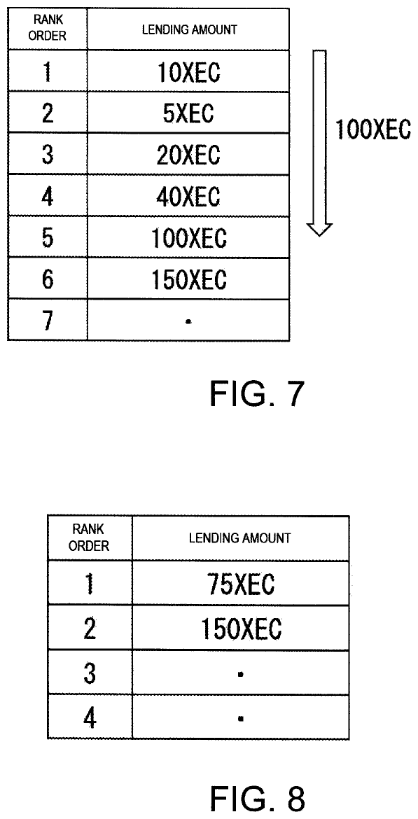

More specifically, the automated trading unit 31a, as shown in FIG. 7, purchases the third party lending virtual currency XEC′ in order of oldest (in order of smallest of the number of “rank order” in FIG. 7) from a lending date until the amount of third party lending virtual currency becomes 100. In the embodiment, all of rank orders 1 to 4 and a part of rank order 5 are applied. Thus, the balance of the third party lending virtual currency XEC′ of the user information DB 32b is updated as shown in FIG. 8.

The automated trading unit 31a sells the third party lending virtual currency XEC′ the amount of which is 100 at an exchange ratio included in the currency exchange instruction to acquire the second fiat currency PHP the amount of which is 5000 (S60).

The automated trading unit 31a increases the balance of the second fiat currency PHP by the amount of second fiat currency PHP acquired by updating the user information DB 32a (S61).

In addition, the automated trading unit 31a updates the user information DB 32 of the user (lending user) lending the virtual currencies XEC of rank orders 1 to 5 in FIG. 6 to increase the balance of the virtual currency XEC by the lending amount of each user, so that the virtual currency XEC is reimbursed to the lending user (S62).

The interest collecting unit 31b updates the user information DB 32a of the first user to decrease the balance of the virtual currency XEC by a preset loan interest (for example, equivalent to 1% of the lending amount of third party lending virtual currency XEC′ purchased in step S57) (S63).

The interest collecting unit 31b updates the user information DBs 32a of the lending users corresponding to rank orders 1 to 5 in FIG. 6 to increase the balance of the virtual currency XEC by a lending interest obtained by multiplying the amount virtual currency XEC lent by each of the lending users by the loan interest (S64).

The interest collecting unit 31b may equally collect the loan interests from the first and second users. In this case, the interest collecting unit 31b updates the user information DBs 32a of the first and second users to subtract amounts obtained by multiplying preset loan interests by 1/2 from the balances of the virtual currencies XEC of the first and second users, respectively.

The virtual currency XEC contributed by a lending user can be purchased by the first fiat currency JPY or the second fiat currency PHP. Thus, the pool information DB 32b distinctively stores a virtual currency XEC-J purchased by the first fiat currency JPY and a virtual currency XEC-P purchased by the second fiat currency PHP to also make it possible to set different loan interests for the virtual currency XEC-J and the virtual currency XEC-P. For example, the loan interest of the virtual currency XEC-P can be set to be higher than the loan interest of the virtual currency XEC-J to make it possible to urge a user to purchase the second fiat currency PHP. Thus, a large amount of money can be exchanged.

Furthermore, a user who exchanges the first fiat currency JPY for the second fiat currency PHP remits the second fiat currency PHP abroad, the user terminal 2, in response to an input operation through the input unit 21 of the user, requests a remittance instruction of the second fiat currency PHP from the marketplace server 3A installed in Japan. The processing unit 31 decreases the amount of second fiat currency PHP of a remittance source user stored in the user information DB 32a by the amount of second fiat currency PHP included in the remittance instruction, so that the marketplace server 3A sends the remittance instruction to the marketplace server 3B.

The marketplace server 3B receives the remittance instruction, the processing unit 31 increases the amount of second fiat currency PHP of a remittance source user stored in the user information DB 32a by the amount of second fiat currency PHP included in the remittance instruction.

In this manner, in the exchange system according to the embodiment, the automated trading unit 31a relatively exchanges the first fiat currency JPY for the second fiat currency PHP through the third party virtual currency XEC′ stored in the pool information DB 32b to exchange the first fiat currency JPY and the second fiat currency PHP the amounts of which are determined by agreement between users in advance at an exchange ratio on which the users agree. For this reason, in comparison with an exchange performed through a marketplace, an amount of money received can be prevented from being small.

In the embodiment described above, an international remittance between Japan and Republic of Philippines has been explained. However, the present invention can be applied to a domestic remittance and an international remittance between two countries except for the two countries described above, as a matter of course.

The present invention can be variously modified without departing from the spirit and scope of the present invention, and the present invention includes the modifieds as a matter of course.

### Reference Numerals

1 remittance system
2 user terminal
21 input unit
22 display unit
23 communication unit (of user terminal)
3, 3A, 3B marketplace server
31 processing unit (of user terminal)
31a automated trading unit
31b interest collecting unit
32 storage unit (of marketplace server)
33 communication unit (of marketplace server)
4 management server
41 processing unit (of management server)
42 storage unit (of management server)
43 communication unit (of management server)
5 network

1. An exchange system which relatively exchanges first and second fiat currencies between users through a virtual currency, comprising:
a user information DB which stores balance information of the virtual currency and the fiat currency for each user;
a pool information DB which stores balance information of a third party lending virtual currency, which is a virtual currency loaned from a third party user; and
an automated trading means which upon receipt of a currency exchange instruction, uses any of first and second fiat currencies to buy the third party lending virtual currency corresponding to a currency exchange amount included in the currency exchange instruction, and sells the third party lending virtual currency and buys the other of the first and second fiat currencies so as to exchange the first and second fiat currencies.

2. The exchange system according to claim 1, wherein the pool information DB stores a lending date of the third party lending virtual currency, and
the automated trading means uses the third party lending virtual currency in order of oldest of the lending date in the exchange of the first and second fiat currencies.

3. The exchange system according to claim 1, wherein the pool information DB stores a loan interest of the third party lending virtual currency, further comprising:
an interest collecting means which, when the first and second fiat currencies are exchanged through the third party lending virtual currency, collects the loan interest from the balance information of the virtual currency of a user who makes the exchange and distributes the loan interest to a third party user which lends out the third party lending virtual currency.

4. The exchange system according to claim 3, wherein the loan interest is set to different values in units of fiat currencies corresponding to the third party lending virtual currency.

5. A remittance system using the exchange system according to claim 1.

6. A method of exchanging fiat currencies between users through a virtual currency comprising the steps of:
maintaining a user information database with an exchange user account balance for each exchange user comprising an exchange user fiat currency balance and an exchange user virtual currency balance;
maintaining a pool information database with a third party lender account balance for each third party lender comprising a third party lender virtual currency balance and a lending date;
receiving a currency exchange instruction from an exchange user;
using one of the fiat currencies to buy from the pool information database the virtual currency from at least one of the third party lenders at a currency exchange amount provided in the currency exchange instruction;
using the virtual currency from the pool information database the virtual currency from at least one of the third party lenders to acquire another one of the fiat currencies; and
wherein an exchange of one of the fiat currencies is made for the another one of the fiat currencies.

7. The method as in claim 6 further comprising the step of:
charging a lending fee to the exchange user.

8. The method as in claim 6 further comprising the step of:
using the third party lender virtual currency balance in rank order from an oldest one of the lending date.
